(19) United States
(12) Patent Application Publication
(10) Pub. No.: US 2024/0259698 A1
(43) Pub. Date: Aug. 1, 2024

(54) POST AUTOMATIC EXPOSURE CONTROL (AEC) AND AUTOMATIC WHITE BALANCE (AWB) PROCESSING TO IMPROVE VIDEO QUALITY

(71) Applicant: QUALCOMM Incorporated, San Diego, CA (US)

(72) Inventors: Zuguang XIAO, San Diego, CA (US); Nan CUI, San Diego, CA (US); Yiqian WANG, San Diego, CA (US)

(21) Appl. No.: 18/163,182

(22) Filed: Feb. 1, 2023

(51) Int. Cl. H04N 23/88; H04N 23/76; H04N 25/51

(52) U.S. Cl. CPC H04N 23/88; H04N 23/76; H04N 25/51

(57) ABSTRACT

Systems, methods, and computer-readable media are provided for performing post automatic exposure control (AEC) and automatic white balance (AWB) processing to improve video quality. In some examples, a computing device can obtain one or more statistics associated with one or more past image frames and one or more future image frames, the one or more past image frames being captured prior to a current image frame and the one or more future image frames being captured subsequent to the current image frame. The computing device can adjust, based on the one or more statistics, at least one of a brightness or a color of the current image frame to generate an adjusted image frame. The computing device can further output the adjusted image frame.

### FIELD

This application is related to image processing. In some examples, aspects of this application relate to systems and techniques for post automatic exposure control (AEC) and automatic white balancing (AWB) processing to improve video quality.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

For image processing, an automatic exposure control (AEC) can be utilized to control the exposure of an image, which can determine the image brightness. An automatic white balance (AWB) can also be utilized in image processing to determine the AWB gain for an image, which can determine the neutral color of the image.

Currently, for existing image processing solutions, AEC and AWB adjustment decisions are based on current image frames. For these solutions, an image signal processor can collect statistics from image data of the current image frames. The AEC and the AWB of the image signal processor can process these statistics, and output their respective adjustment decisions. The AEC and the AWB can also refer to their previous adjustment decisions. Based on the current image frame statistics and the previous adjustment decisions, the AEC and the AWB can determine their adjustment decisions for the current image frame. The adjustment decision from the AEC can include sensor settings for time and gain, and the adjustment decision from the AWB can include a red-green-blue (RGB) gain. These AEC and AWB adjustment decisions can be applied to the current image frame by the image signal processor.

However, in some cases, for example when there is a small scene change that occurs because the camera is moved abruptly, since these solutions cannot predict future image frames, the AEC and AWB adjustment decisions may not be accurate or result in a smooth transition between the image frames. In some examples, when the camera is abruptly moved slightly, these solutions can result in a fluctuation of the brightness and tone between image frames of the video. As such, a solution for post processing AEC and AWB to improve video quality can be useful.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for post AEC and AWB processing to improve video quality. According to at least one example, a method for processing image data is provided. The method includes: obtaining one or more statistics associated with one or more past image frames and one or more future image frames, the one or more past image frames being captured prior to a current image frame and the one or more future image frames being captured subsequent to the current image frame; adjusting, based on the one or more statistics, at least one of a brightness or a color of the current image frame to generate an adjusted image frame; and outputting the adjusted image frame.

In another illustrative example, an apparatus for processing image data is provided. The apparatus includes at least one memory and at least one processor coupled to the at least one memory and configured to: obtain one or more statistics associated with one or more past image frames and one or more future image frames, the one or more past image frames being captured prior to a current image frame and the one or more future image frames being captured subsequent to the current image frame; adjust, based on the one or more statistics, at least one of a brightness or a color of the current image frame to generate an adjusted image frame; and output the adjusted image frame.

In another illustrative example, a non-transitory computer-readable medium is provided having stored thereon instructions that, when executed by at least one processor, cause the at least one processor to: obtain one or more statistics associated with one or more past image frames and one or more future image frames, the one or more past image frames being captured prior to a current image frame and the one or more future image frames being captured subsequent to the current image frame; adjusting, based on the one or more statistics, at least one of a brightness or a color of the current image frame to generate an adjusted image frame; and outputting the adjusted image frame

In another illustrative example, an apparatus for processing image data is provided. The apparatus includes: means for obtaining one or more statistics associated with one or more past image frames and one or more future image frames, the one or more past image frames being captured prior to a current image frame and the one or more future image frames being captured subsequent to the current image frame; means for adjusting, based on the one or more statistics, at least one of a brightness or a color of the current image frame to generate an adjusted image frame; and means for outputting the adjusted image frame.

Aspects generally include a method, apparatus, system, computer program product, non-transitory computer-readable medium, user device, user equipment, wireless communication device, and/or processing system as substantially described with reference to and as illustrated by the drawings and specification.

In some aspects, one or more of the apparatuses described herein is, can be part of, or can include a mobile device (e.g., a mobile telephone or so-called “smart phone” or other mobile device), an extended reality (XR) device (e.g., a virtual reality (VR) device, an augmented reality (AR) device, or a mixed reality (MR) device), a camera system, a smart or connected device (e.g., an Internet-of-Things (IoT) device), a vehicle or a computing system or device of the vehicle, a wearable device (e.g., a network-connected watch or other wearable device), a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Examples of various implementations are described in detail below with reference to the following figures:

FIG. 1 is a block diagram illustrating an example architecture of an image capture and processing system, in accordance with some examples.

FIG. 2 is a block diagram illustrating an example of interactions between components of an image capture and processing system, in accordance with some examples.

FIG. 3 is a block diagram of an example device that may be used for post AEC and AWB processing to improve video quality, in accordance with some examples.

FIG. 4 is a block diagram showing the operation of an image signal processor pipeline, in accordance with some examples.

FIG. 5 are graphs that show an example of image data with fluctuations in tone and/or brightness being smoothed out after applying a compensation and/or temporal filtering, in accordance with some examples.

FIG. 6 is a diagram illustrating an example of a system for post AEC and AWB processing to improve video quality, in accordance with some examples.

FIG. 7 is a flow diagram illustrating another example of a process for post AEC and AWB processing to improve video quality, in accordance with some examples.

FIG. 8 is a diagram illustrating an example of a system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, for image processing, for example by an image signal processor, an AEC can be utilized to control the exposure of an image, which can determine the image brightness. An AWB can also be utilized in image processing to determine the AWB gain for an image, which can determine the neutral color of the image.

In existing image processing solutions, AEC and AWB adjustment decisions are based on current image frames. For these solutions, an image signal processor can collect statistics from image data of the current image frames. The AEC and the AWB of the image signal processor can process the statistics, and output their respective adjustment decisions. The AEC and the AWB can also refer to their previous adjustment decisions. Based on the current image frame statistics and the previous adjustment decisions, the AEC and the AWB can determine their adjustment decisions for the current image frame. The adjustment decision from the AEC can include sensor settings for time and gain (e.g., a digital gain), and the adjustment decision from the AWB can include a red-green-blue (RGB) gain. These AEC and AWB adjustment decisions can be applied to the current image frame by the image signal processor.

Typically, the AEC and AWB are designed to not be too sensitive such that, if there is a small scene change (e.g., which may occur due to the camera being abruptly moved slightly), the AEC and AWB adjustment decisions should result in a smooth scene transition in the video. When there is an actual scene change, the AEC and AWB are designed to converge to the new scene quickly such that the color and exposure are accurate for that scene.

However, since these existing solutions cannot predict future scenes (e.g., future image frames), the AEC and AWB adjustment decisions may not be accurate or result in a smooth transition between the image frames. As such, in some examples, when the camera is abruptly moved slightly, these solutions can result in a fluctuation of the brightness and tone between image frames of the video. As such, a solution for post processing AEC and AWB to improve video quality can be beneficial.

Accordingly, systems, apparatuses, processes (also referred to as methods), and computer-readable media (collectively referred to herein as “systems and techniques”) are described herein for post AEC and AWB processing to improve video quality. For instance, in some examples, the systems and techniques can render a current image frame by adjusting the brightness and/or color based on past image frames and future image frames. In one or more examples, a digital gain and/or an AWB gain may be applied on the current image frame to compensate for fluctuations in brightness and/or color, when the current image frame has a different brightness and/or different color relative to its neighboring image frames. In one or more examples, an image frame may be a single still image captured by a camera, such as an RGB camera, or may be a frame of video captured by a camera, such as a video camera. In some examples, by using the systems and techniques, contrast, noise, and/or other image characteristics can also be adjusted to ensure the overall image quality (IQ).

Further aspects of the systems and techniques are described with respect to the figures.

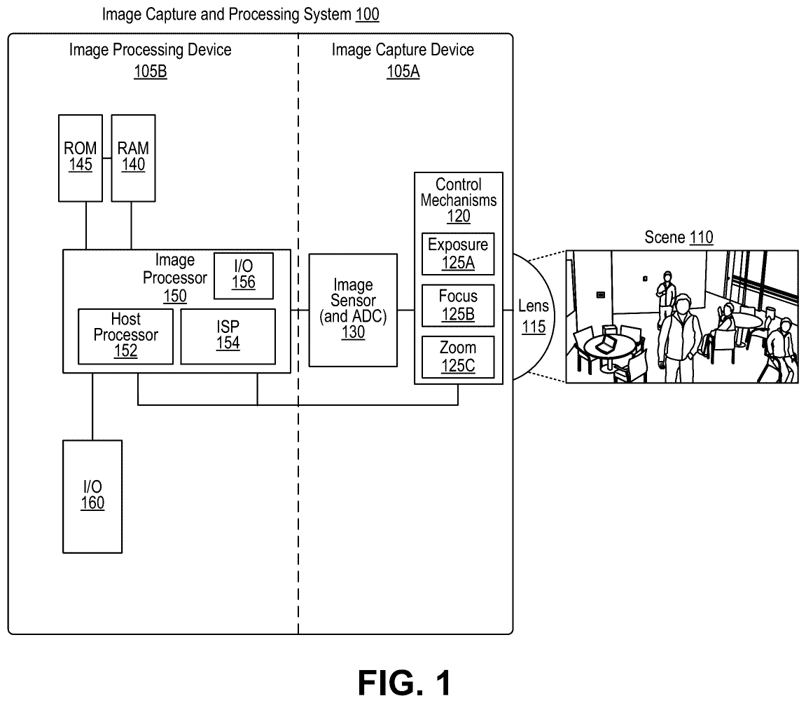

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 810 discussed with respect to the computing system 800. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/820, read-only memory (ROM) 145/825, a cache 812, a memory unit 815, another storage device 830, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 835, any other input devices 845, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some examples, the host processor 152 can perform electronic image stabilization (EIS). For instance, the host processor 152 can determine a motion vector corresponding to motion compensation for one or more image frames. In some aspects, host processor 152 can position a cropped pixel array (“the image window”) within the total array of pixels. The image window can include the pixels that are used to capture images. In some examples, the image window can include all of the pixels in the sensor, except for a portion of the rows and columns at the periphery of the sensor. In some cases, the image window can be in the center of the sensor while the image capture device 105A is stationary. In some aspects, the peripheral pixels can surround the pixels of the image window and form a set of buffer pixel rows and buffer pixel columns around the image window. Host processor 152 can implement EIS and shift the image window from frame to frame of video, so that the image window tracks the same scene over successive frames (e.g., assuming that the subject does not move). In some examples in which the subject moves, host processor 152 can determine that the scene has changed.

In some examples, the image window can include at least 95% (e.g., 95% to 99%) of the pixels on the sensor. The first region of interest (ROI) (e.g., used for AE and/or AWB) may include the image data within the field of view of at least 95% (e.g., 95% to 99%) of the plurality of imaging pixels in the image sensor 130 of the image capture device 105A. In some aspects, a number of buffer pixels at the periphery of the sensor (outside of the image window) can be reserved as a buffer to allow the image window to shift to compensate for jitter. In some cases, the image window can be moved so that the subject remains at the same location within the adjusted image window, even though light from the subject may impinge on a different region of the sensor. In another example, the buffer pixels can include the ten topmost rows, ten bottommost rows, ten leftmost columns and ten rightmost columns of pixels on the sensor. In some configurations, the buffer pixels are not used for AF, AE or AWB when the image capture device 105A is stationary and the buffer pixels not included in the image output. If jitter moves the sensor to the left by twice the width of a column of pixels between frames, the EIS algorithm can be used to shift the image window to the right by two columns of pixels, so the captured image shows the same scene in the next frame as in the current frame. Host processor 152 can use EIS to smoothen the transition from one frame to the next.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations. In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

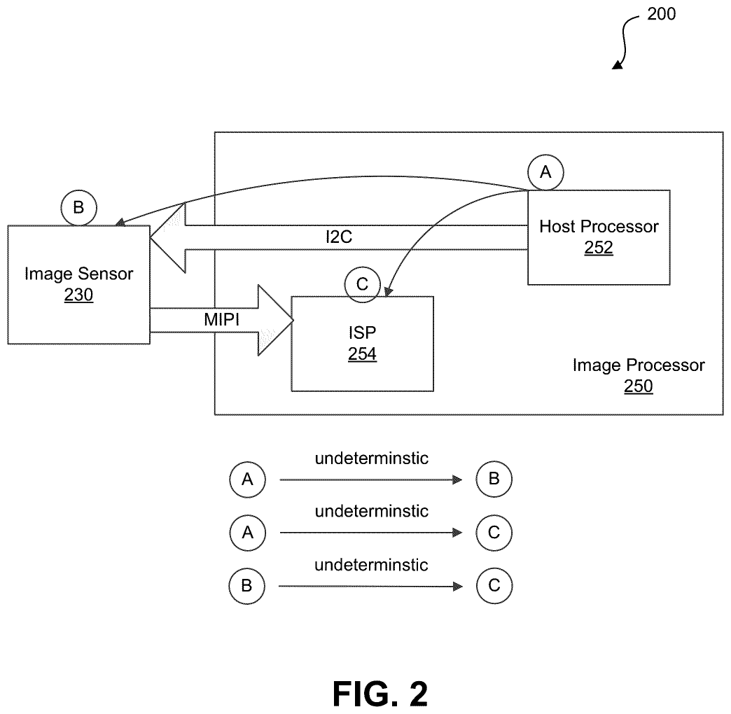

Synchronization between the image sensor 130 and the ISP 154 is important in order to provide an operational image capture system that generates high quality images without interruption and/or failure. FIG. 2 is a block diagram illustrating an example of an image capture and processing system 200 including an image processor 250 (including host processor 252 and ISP 254) in communication with an image sensor 230. The configuration shown in FIG. 2 is illustrative of traditional synchronization techniques used in camera systems. In general, the host processor 252 attempts to provide synchronization between the image sensor 230 and the ISP 254 using fixed periods of time by separately communicating with the image sensor 230 and the ISP 254. For example, in traditional camera systems, the host processor 252 communicates with the image sensor 230 (e.g., over an I2C port) and programs the image sensor 230 parameters with a first fixed period of time, such as 2-frame periods ahead of when that image frame will be processed by the ISP 254. The host processor 252 communicates with the ISP 254 (e.g., over an internal AHB bus or other interface) and programs the ISP 254 parameter settings with a second fixed period of time, such as 1-frame period ahead of when that image frame will be processed by the ISP 254.

The image sensor 230 can send image frames to the ISP 254 (B-to-C in FIG. 2), such as over an MIPI CSI-2 PHY port or interface, or other suitable interface. However, the communication between the host processor 252 and the image sensor 230 (shown as from A to B) is undeterministic. Similarly, the communication between the image sensor 230 and the ISP 254 (shown as from B to C) and the communication the host processor 252 and the ISP 254 (shown as from A to C) are also undeterministic. For example, there can be varying latencies in programming of the image sensor 230 and the ISP 254 by the host processor 252, which can result in a parameter settings mismatch between the sensor and the ISP. The latencies can be due to high CPU usage, congestion in one or more I/O ports, and/or due to other factors.

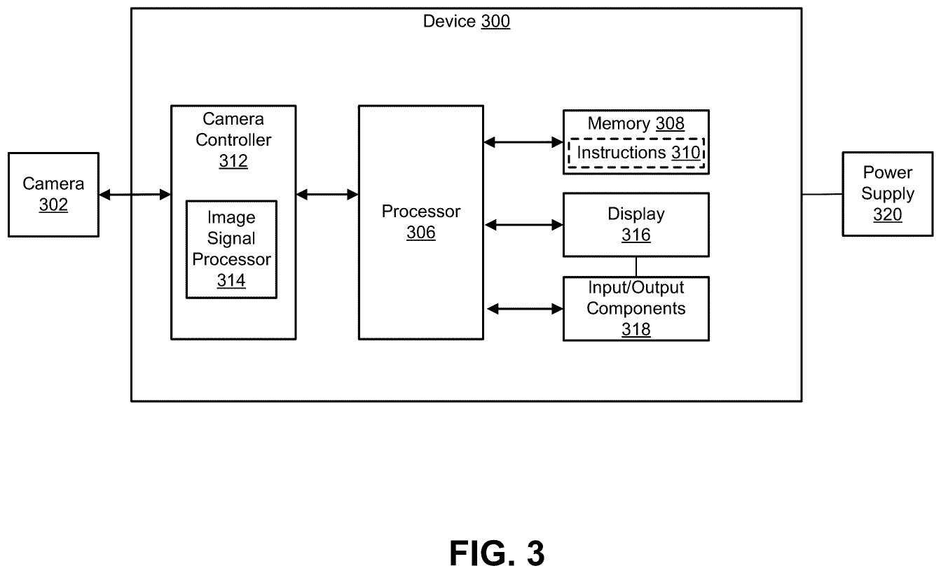

FIG. 3 is a block diagram of an example device 300 that may be used for post AEC and AWB processing to improve video quality. Device 300 may include or may be coupled to a camera 302, and may further include a processor 306, a memory 308 storing instructions 310, a camera controller 312, a display 316, and a number of input/output (I/O) components 318 including one or more microphones (not shown). The example device 300 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device. The device 300 may include additional features or components not shown. For example, a wireless interface, which may include a number of transceivers and a baseband processor, may be included for a wireless communication device. Device 300 may include or may be coupled to additional cameras other than the camera 302. The disclosure should not be limited to any specific examples or illustrations, including the example device 300.

Camera 302 may be capable of capturing individual image frames (such as still images) and/or capturing video (such as a succession of captured image frames). Camera 302 may include one or more image sensors (not shown for simplicity) and shutters for capturing an image frame and providing the captured image frame to camera controller 312. Although a single camera 302 is shown, any number of cameras or camera components may be included and/or coupled to device 300. For example, the number of cameras may be increased to achieve greater depth determining capabilities or better resolution for a given FOV.

Memory 308 may be a non-transient or non-transitory computer readable medium storing computer-executable instructions 310 to perform all or a portion of one or more operations described in this disclosure. Device 300 may also include a power supply 320, which may be coupled to or integrated into the device 300.

Processor 306 may be one or more suitable processors capable of executing scripts or instructions of one or more software programs (such as the instructions 310) stored within memory 308. In some aspects, processor 306 may be one or more general purpose processors that execute instructions 310 to cause device 300 to perform any number of functions or operations. In additional or alternative aspects, processor 306 may include integrated circuits or other hardware to perform functions or operations without the use of software. While shown to be coupled to each other via processor 306 in the example of FIG. 3, processor 306, memory 308, camera controller 312, display 316, and I/O components 318 may be coupled to one another in various arrangements. For example, processor 306, memory 308, camera controller 312, display 316, and/or I/O components 318 may be coupled to each other via one or more local buses (not shown for simplicity).

Display 316 may be any suitable display or screen allowing for user interaction and/or to present items (such as captured images and/or videos) for viewing by the user. In some aspects, display 316 may be a touch-sensitive display. Display 316 may be part of or external to device 300. Display 316 may comprise an LCD, LED, OLED, or similar display. I/O components 318 may be or may include any suitable mechanism or interface to receive input (such as commands) from the user and/or to provide output to the user. For example, I/O components 318 may include (but are not limited to) a graphical user interface, keyboard, mouse, microphone and speakers, and so on.

Camera controller 312 may include an image signal processor (ISP) 314, which may be (or may include) one or more image signal processors to process captured image frames or videos provided by camera 302. For example, ISP 314 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 312 (such as the ISP 314) may implement various functionality, including imaging processing and/or control operation of camera 302. In some aspects, ISP 314 may execute instructions from a memory (such as instructions 310 stored in memory 308 or instructions stored in a separate memory coupled to ISP 314) to control image processing and/or operation of camera 302. In other aspects, ISP 314 may include specific hardware to control image processing and/or operation of camera 302. ISP 314 may alternatively or additionally include a combination of specific hardware and the ability to execute software instructions.

While not shown in FIG. 3, in some implementations, ISP 314 and/or camera controller 312 may include an AF module, an AWB module, and/or an AE module. ISP 314 and/or camera controller 312 may be configured to execute an AF process, an AWB process, and/or an AE process. In some examples, ISP 314 and/or camera controller 312 may include hardware-specific circuits (e.g., an application-specific integrated circuit (ASIC)) configured to perform the AF, AWB, and/or AE processes. In other examples, ISP 314 and/or camera controller 312 may be configured to execute software and/or firmware to perform the AF, AWB, and/or AE processes. When configured in software, code for the AF, AWB, and/or AE processes may be stored in memory (such as instructions 310 stored in memory 308 or instructions stored in a separate memory coupled to ISP 314 and/or camera controller 312). In other examples, ISP 314 and/or camera controller 312 may perform the AF, AWB, and/or AE processes using a combination of hardware, firmware, and/or software. When configured as software, AF, AWB, and/or AE processes may include instructions that configure ISP 314 and/or camera controller 312 to perform various image processing and device managements tasks, including the techniques of this disclosure.

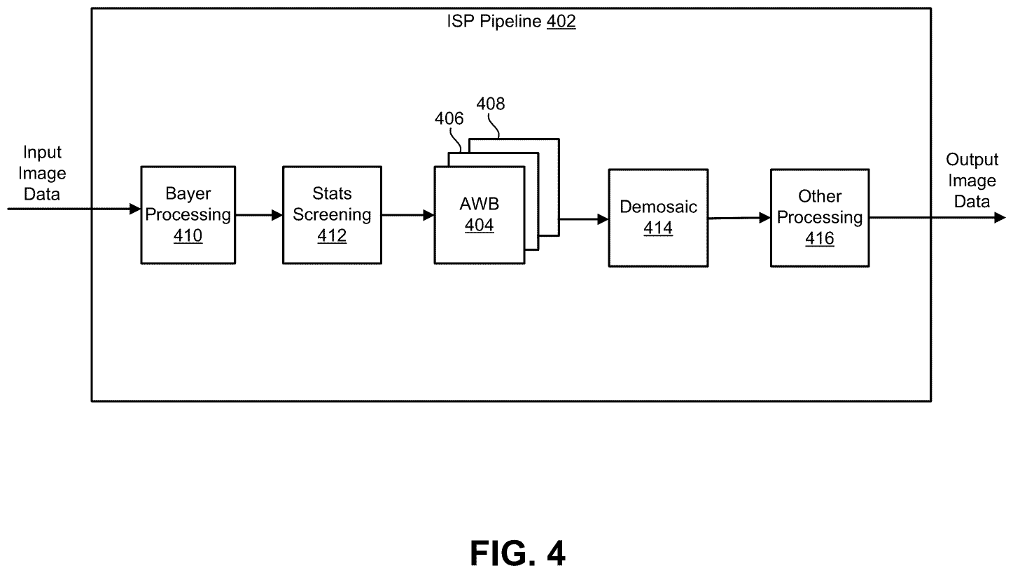

FIG. 4 is a block diagram showing the operation of an image signal processing pipeline 402 of an image signal processor (e.g., the ISP 314). For example, the ISP 314 may be configured to execute the image signal processing pipeline 402 to process input image data. The ISP 314 may receive the input image data from camera 302 of FIG. 3 and/or an image sensor (not shown) of camera 302. In some examples, such as shown in FIG. 4, the input image data may include color data of the image/frame and/or any other data (e.g., depth data). In the example of FIG. 4, the color data received for the input image data may be in a Bayer format. Rather than capturing red (R), green (G), and blue (B) values for each pixel of an image, image sensors (e.g., an image sensor of camera 302) may use a Bayer filter mosaic (or more generally, a color filter array (CFA)), where each photosensor of a digital image sensor captures a different one of the RGB colors. One example of a filter pattern for a Bayer filter mosaic may include 50% green filters, 25% red filters, and 25% blue filters.

Bayer processing unit 410 may perform one or more initial processing techniques on the raw Bayer data received by ISP 314, including, for example, subtraction, rolloff correction, bad pixel correction, black level compensation, and/or denoising.

Statistics (stats) screening process 412 may determine Bayer grade or Bayer grid (BG) statistics of the received input image data. In some examples, BG statistics may include a red color to green color ratio (R/G) (which may indicate whether a red tinting exists and the magnitude of the red tinting that may exist in an image) and/or a blue color to green color ratio (B/G) (which may indicate whether a blue tinting exists and the magnitude of the blue tinting that may exist in an image). For example, the (R/G) for an image or a portion/region of an image may be depicted by equation (1) below:

$$R / G = \frac{{\sum }_{n = 1}^{N} Red ( n )}{{\sum }_{n = 1}^{N} Green ( n )} \qquad ( 1 )$$

where the image or a portion/region of the image includes pixels 1-N, each pixel n includes a red value Red(n), a blue value Blue(n), or a green value Green(n) in an RGB space. The (R/G) is the sum of the red values for the red pixels in the image divided by the sum of the green values for the green pixels in the image. Similarly, the (B/G) for the image or a portion/region of the image may be depicted by equation (2) below:

$$B / G = \frac{{\sum }_{n = 1}^{N} Blue ( n )}{{\sum }_{n = 1}^{N} Green ( n )} \qquad ( 2 )$$

In some other example implementations, a different color space may be used, such as Y′UV, with chrominance values UV indicating the color, and/or other indications of a tinting or other color temperature effect for an image may be determined.

AWB module and/or process 404 may analyze information relating to the received image data to determine an illuminant of the scene, from among a plurality of possible illuminants, and may determine an AWB gain to apply to the received image and/or a subsequent image based on the determined illuminant. White balance is a process used to try to match colors of an image with a user's perceptual experience of the object being captured. As an example, the white balance process may be designed to make white objects actually appear white in the processed image and gray objects actually appear gray in the processed image.

An illuminant may include a lighting condition, a type of light, etc. of the scene being captured. In some examples, a user of an image capture device (e.g., such as device 300 of FIG. 3) may select or indicate an illuminant under which an image was captured. In other examples, the image capture device itself may automatically determine the most likely illuminant and perform white balancing based on the determined illuminant (e.g., lighting condition). In order to better render the colors of a scene in a captured image or video, an AWB algorithm on a device and/or camera may attempt to determine the illuminants of the scene and set/adjust the white balance of the image or video accordingly.

Device 300, during the AWB process 404, may determine or estimate a color temperature for a received frame (e.g., image). The color temperature may indicate a dominant color tone for the image. The true color temperature for a scene being captured in a video or image is the color of the light sources for the scene. If the light is radiation emitted from a perfect blackbody radiator (theoretically ideal for all electromagnetic wavelengths) at a particular color temperature (represented in Kelvin (K)), and the color temperatures are known, then the color temperature for the scene is known. For example, in a Commission Internationale de l'éclairage (CIE) defined color space (from 1931), the chromaticity of radiation from a blackbody radiator with temperatures from 1,000 to 20,000 K is the Planckian locus. Colors on the Planckian locus from approximately 2,000 K to 20,000 K are considered white, with 2,000 K being a warm or reddish white and 20,000 K being a cool or bluish white. Many incandescent light sources include a Planckian radiator (tungsten wire or another filament to glow) that emits a warm white light with a color temperature of approximately 2,400 to 3,100 K.

However, other light sources, such as fluorescent lights, discharge lamps, or light emitting diodes (LEDs), are not perfect blackbody radiators whose radiation falls along the Planckian locus. For example, an LED or a neon sign emit light through electroluminescence, and the color of the light does not follow the Planckian locus. The color temperature determined for such light sources may be a correlated color temperature (CCT). The CCT is the estimated color temperature for light sources whose colors do not fall exactly on the Planckian locus. For example, the CCT of a light source is the blackbody color temperature that is closest to the radiation of the light source. CCT may also be denoted in K.

CCT may be an approximation of the true color temperature for the scene. For example, the CCT may be a simplified color metric of chromaticity coordinates in the CIE 1931 color space. Many devices may use AWB to estimate a CCT for color balancing.

The CCT may be a temperature rating from warm colors (such as yellows and reds below 3200 K) to cool colors (such as blue above 4000 K). The CCT (or other color temperature) may indicate the tinting that will appear in an image captured using such light sources. For example, a CCT of 2700 K may indicate a red tinting, and a CCT of 5000 K may indicate a blue tinting.

Different lighting sources or ambient lighting may illuminate a scene, and the color temperatures may be unknown to the device. As a result, the device may analyze data captured by the image sensor to estimate a color temperature for an image (e.g., a frame). For example, the color temperature may be an estimation of the overall CCT of the light sources for the scene in the image. The data captured by the image sensor used to estimate the color temperature for a frame (e.g., image) may be the captured image itself.

After device 300 determines a color temperature for the scene (such as during performance of AWB), device 300 may use the color temperature to determine a color balance for correcting any tinting in the image. For example, if the color temperature indicates that an image includes a red tinting, device 300 may decrease the red value or increase the blue value for each pixel of the image, e.g., in an RGB space. The color balance may be the color correction (such as the values to reduce the red values or increase the blue values).

Example inputs to AWB process 404 may include the Bayer grade or Bayer grid (BG) statistics of the received image data determined via statistics screening process 412, an exposure index (e.g., the brightness of the scene of the received image data), and auxiliary information, which may include the contextual information of the scene based on the audio input (as will be discussed in further detail below), depth information, etc. It should be noted that AWB process 404 may be included within camera controller 312 of FIG. 3 as a separate AWB module.

AE process 406 may include instructions for configuring, calculating, and/or storing an exposure setting of camera 302 of FIG. 3. An exposure setting may include an amount of sensor gain to be applied, an amount of digital gain to be applied, shutter speed and/or exposure time, an aperture setting, and/or an ISO setting to use to capture subsequent images. AE process 406 may use the audio input and/or the contextual information of the scene based on the audio input to determine and/or apply exposure settings faster. It should be noted that AE process 406 may be included within camera controller 312 of FIG. 3 as a separate AE module.

AF process 408 may include instructions for configuring, calculating and/or storing an auto focus setting of camera 302 of FIG. 3. AF process 408 may determine the auto focus setting (e.g., an initial lens position, a final lens position, etc.) based on the audio input and/or the contextual information of the scene based on the audio input. It should be noted that AF process 408 may be included within camera controller 312 of FIG. 3 as a separate AF module.

Demosaic processing unit 414 may be configured to convert the processed Bayer image data into RGB values for each pixel of an image. As explained above, Bayer data may only include values for one color channel (R, G, or B) for each pixel of the image. Demosaic processing unit 414 may determine values for the other color channels of a pixel by interpolating from color channel values of nearby pixels. In some ISP pipelines 402, demosaic processing unit 414 may come before AWB, AE, and/or AF processes 404, 406, 408 or after AWB, AE, and/or AF processes 404, 406, 408.

Other processing unit 416 may apply additional processing to the image after AWB, AE, and/or AF processes 404, 406, 408 and/or demosaic processing unit 414. The additional processing may include color, tone, and/or spatial processing of the image.

As previously mentioned, for image processing, for example by an ISP (e.g., the ISP 154 of FIG. 1, ISP 254 of FIG. 2, and/or ISP 314 of FIGS. 3 and 4), an AEC (e.g., an AEC module, which may be located within camera controller 312 of FIG. 3 and may perform the AE process 406 of FIG. 4) can be utilized to control the exposure of an image, which can determine the image brightness. An AWB (e.g., an AWB module, which may be located within camera controller 312 of FIG. 3 and may perform the AWB process 404 of FIG. 4) can also be utilized in image processing (e.g., by the ISP) to determine the AWB gain for an image, which can determine the neutral color of the image. The goal of an AEC is to adjust the settings of an image sensor (e.g., image sensor 130 of FIG. 1 and/or image sensor 230 of FIG. 2) such that the image (e.g., of an image frame) has proper exposure. The goal of an AWB is to make the color of the image (e.g., of an image frame) balanced with respect to a reference white point.

In existing image processing solutions, AEC and AWB adjustment decisions are based on current image frames. For these solutions, an image signal processor can collect statistics from image data of the current image frames. The AEC and the AWB of the image signal processor can process the statistics, and output their respective adjustment decisions. The AEC and the AWB can also refer to their previous adjustment decisions. Based on the current image frame statistics and the previous adjustment decisions, the AEC and the AWB can determine their adjustment decisions for the current image frame. The adjustment decision from the AEC can include sensor settings for time and gain (e.g., digital gain), and the adjustment decision from the AWB can include a RGB gain. These AEC and AWB adjustment decisions can be applied to the current image frame by the image signal processor.

Typically, the AEC and AWB are designed to not be too sensitive such that, if there is a small scene change (e.g., which may occur due to the camera being abruptly moved slightly), the AEC and AWB adjustment decisions should result in a smooth scene transition in the video. When there is an actual scene change, the AEC and AWB are designed to converge to the new scene quickly such that the color and exposure are accurate for that scene.

However, since these existing solutions cannot predict future scenes (e.g., future image frames), the AEC and AWB adjustment decisions may not be accurate and/or result in a smooth transition between the image frames. As such, in some examples, when the camera is abruptly moved slightly, these solutions can result in a fluctuation of the brightness and tone between image frames of the video. For these existing solutions, when the AEC and AWB determine inaccurate or non-optimal decisions, the deleterious effects of those decisions will be applied to the current image frame. The current image frame, prior to having those non-optimal decisions applied to it, cannot be saved and, as such, the image will be viewed in both the video preview and video recording as having those deleterious effects. As such, solution for post processing AEC and AWB to improve video quality can be useful.

In one or more aspects, the systems and techniques provide post AEC and AWB processing to improve video quality. The systems and techniques can render a current image frame by adjusting the brightness and/or color based on past image frames and future image frames. In one or more examples, a digital gain and/or an AWB gain can be applied to the current image frame to compensate for fluctuations in brightness and/or color, when the current image frame has a different brightness and/or different color relative to its neighboring image frames. In one or more examples, an image frame may be a single still image captured by a camera (e.g., an RGB camera), or may be a frame of video captured by a camera (e.g., a video camera). In some examples, by using the systems and techniques, contrast, noise, and/or other image characteristics can also be adjusted to ensure the overall IQ.

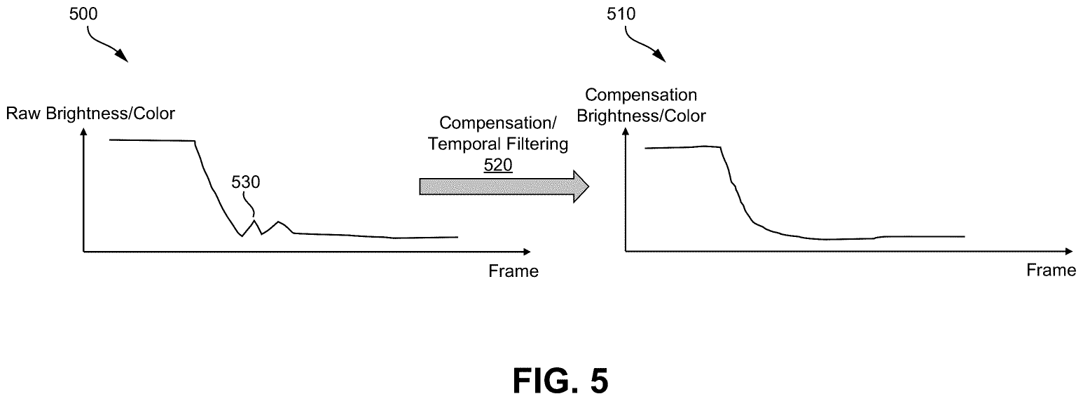

FIG. 5 are graphs 500, 510 that show an example of image data (e.g., brightness and/or color image data) with fluctuations in tone (color) and/or brightness being smoothed out after applying a compensation and/or temporal filtering 520. In particular, FIG. 5 shows an example showing image data (e.g., brightness and/or color image data), exhibiting fluctuations in tone (color) and/or brightness, having its fluctuations being smoothed out after having sensor settings (e.g., from an AEC decision) and/or an AWB gain (e.g., from an AWB decision) applied for at least some of the image data.

In FIG. 5, for the graph 500, the x-axis denotes image frame numbers (e.g., for image frames within a video recording) and the y-axis denotes raw brightness and/or color image data for image frames. For the graph 510, the x-axis denotes the image frame numbers and the y-axis denotes compensated brightness and/or color image data for the image frames.

In graph 500, the raw brightness and/or color image data for a plurality of image frames (e.g., from a video recording) is plotted in a curve. The curve of graph 500 is shown to exhibit fluctuations (e.g., fluctuation 530) in the raw brightness and/or color image data for some of the image frames. The curve of graph 500 shows that some of the image frames have abrupt brightness and/or color transitions (e.g., at the point of fluctuation 530) between them and, as such, video (including image frames with the raw brightness and/or color image data) may exhibit flickering effects.

Compensation and/or temporal filtering 520 can be applied for at least some of the image frames to generate the compensated raw brightness and/or color image data. In one or more examples, the compensation and/or temporal filtering 520 can include sensor settings for a time and gain (e.g., a digital gain) from an AEC decision and/or an AWB gain (e.g., an RGB gain) from an AWB decision.

In graph 510, the compensated raw brightness and/or color image data for the plurality of image frames is plotted in a curve. The curve of graph 510 is shown to be smooth, such that the fluctuations (e.g., fluctuation 530) that were present in the raw brightness and/or color image data of the curve of graph 500 are not present in the curve of graph 510. The curve of graph 510 shows that the image frames have smooth brightness and/or color transitions between them and, as such, video (including image frames with the compensated brightness and/or color image data) should not exhibit any flickering effects.

As previously mentioned, the systems and techniques can provide post AEC and AWB processing to improve video quality by rendering a current image frame by adjusting the brightness and/or color based on past image frames and future image frames. A digital gain (e.g., from an AEC decision) and/or an AWB gain (e.g., from an AWB decision) can be applied to the current image frame to compensate for fluctuations in brightness and/or color, when the current image frame has a different brightness and/or different color relative to its neighboring image frames.

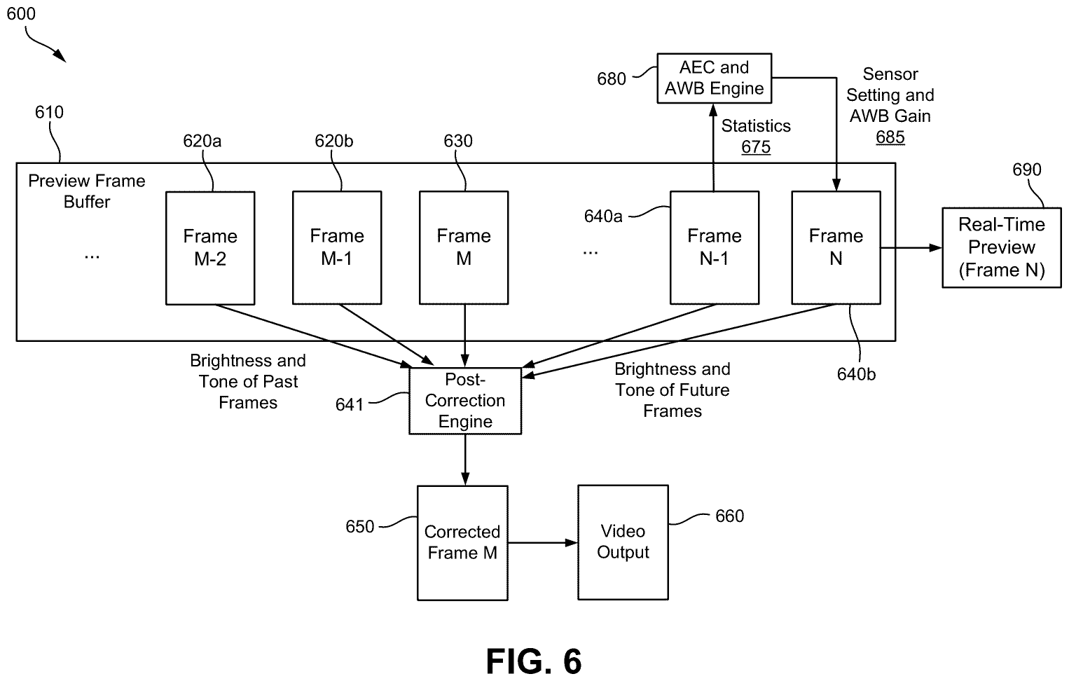

FIG. 6 is a diagram illustrating an example of a system 600 for post AEC and AWB processing to improve video quality. In particular, in FIG. 6, the system 600 employs frame buffering (e.g., within a preview frame buffer 610) for the post AEC and AWB processing of the video. In FIG. 6, the preview frame buffer 610 is shown to include a plurality of past image frames (e.g., past image frame M-2 620a and past image frame M-1 620b) of the video, a current image frame (e.g., image frame M 630) of the video, and a plurality of future image frames (e.g., future image frame N-1 640a and future image frame N 640b) of the video. A real time preview 690 of all of the image frames, except for the future image frame (e.g., image frame N 640b) to be displayed at a time the furthest in the future, may occur.

During operation of the system 600 of FIG. 6 for post AEC and AWB processing to improve the quality of the video, an image sensor (e.g., image sensor 130 of FIG. 1 and/or image sensor 230 of FIG. 2) of a camera (e.g., image capture device 105A of FIG. 1 and/or camera 302 of FIG. 3) may capture scenes (e.g., scene 110 of FIG. 1) in image frames of video.

After the camera has obtained the image frames of the captured the scenes, the image frames can be transferred (e.g., transmitted) to the preview frame buffer 610. As the image frames are loaded into the preview frame buffer 610, the image frames can include the past image frames (e.g., past image frame M-2 620a and past image frame M-1 620b), the current image frame (e.g., image frame M 630), and the future image frames (e.g., future image frame N-1 640a and future image frame N 640b).

The past image frames (e.g., past image frame M-2 620a and past image frame M-1 620b) are image frames that have been captured, loaded into the preview frame buffer 610, and displayed. The current image frame (e.g., image frame M 630) is an image frame that has been captured, loaded into the preview frame buffer 610, and can be displayed at a current time. The future image frames (e.g., future image frame N-1 640a and future image frame N 640b) are image frames that have been captured and loaded into the preview frame buffer 610, but will not be displayed until a future time after the current time.

After the image frames have been loaded into the preview frame buffer 610, the image frames can be processed, for example by an ISP (e.g., the ISP 154 of FIG. 1, ISP 254 of FIG. 2, and/or ISP 314 of FIGS. 3 and 4). For the image frame processing, an AEC and AWB engine 680 can perform AEC and AWB algorithms on one or more of the image frames. The AEC and AWB engine 680 may be part of the camera controller 312 of FIG. 3. A goal of an AEC is to adjust the settings of an image sensor (e.g., image sensor 130 of FIG. 1 and/or image sensor 230 of FIG. 2) such that the image frame (e.g., the current image frame, such as image frame M 630) is captured using a proper exposure. A goal of an AWB is to ensure that the color of the image frame (e.g., of the current image frame, such as image frame M 630) is balanced with respect to a reference white point.

During operation, the AEC and AWB engine 680 can use statistics 675, which are related to brightness and tone, from the past image frames (e.g., past image frame M-2 620a and past image frame M-1 620b) and the future image frames (e.g., future image frame N-1 640a and future image frame N 640b) to determine sensor settings and an AWB gain 685, such as to adjust a brightness and/or a color of the current image frame (e.g., the image frame M 630) to generate an adjusted image frame. For example, when performing AEC, the AEC and AWB engine 680 can use the statistics 675 from the past image frames (e.g., past image frame M-2 620a and past image frame M-1 620b) and the future image frames (e.g., future image frame N-1 640a and future image frame N 640b) to determine the sensor settings 685 (e.g., for a time and gain, such as a digital gain) for the brightness for the current image frame (e.g., image frame M 630). Additionally or alternatively, when performing AWB, the AEC and AWB engine 680 can use the statistics 675 from the past image frames (e.g., past image frame M-2 620a and past image frame M-1 620b) and the future image frames (e.g., future image frame N-1 640a and future image frame N 640b) to determine the AWB gain 685 (e.g., RGB gain) for the neutral color of the current image frame (e.g., image frame M 630).

After the AEC and AWB engine 680 has determined the sensor settings and AWB gain 685, the determined sensor settings and AWB gain 685 can be applied to the future image frame (e.g., image frame N 640b) that is to be displayed at a time furthest in the future after the current time.

Also during operation, a post correction engine 641 can perform a post correction algorithm to process the current image frame (e.g., image frame M 630). In some cases, the post correction engine 641 can be run by a processor (e.g., other processing unit 416 of FIG. 4 within an ISP, such as the ISP 154 of FIG. 1, ISP 254 of FIG. 2, and/or ISP 314 of FIGS. 3 and 4). In particular, the post correction engine 641 can apply the determined sensor settings and AWB gain 685 to the current image frame (e.g., image frame M 630) to correct (e.g., compensate) the image of the current image frame (e.g., image frame M 630) to render a corrected current image frame (e.g., frame M corrected 650). When the sensor settings and AWB gain 685 are applied to the current image frame (e.g., image frame M 630), the brightness and/or tone in the image of the current image frame (e.g., image frame M 630) can be compensated.

Then, the corrected current image frame (e.g., frame M corrected 650) can be part of the video recording output 660 to be viewed by a user. After the current image frame (e.g., image frame M 630) is processed, the next current image frame (e.g., image frame M-1 620b) can be processed.

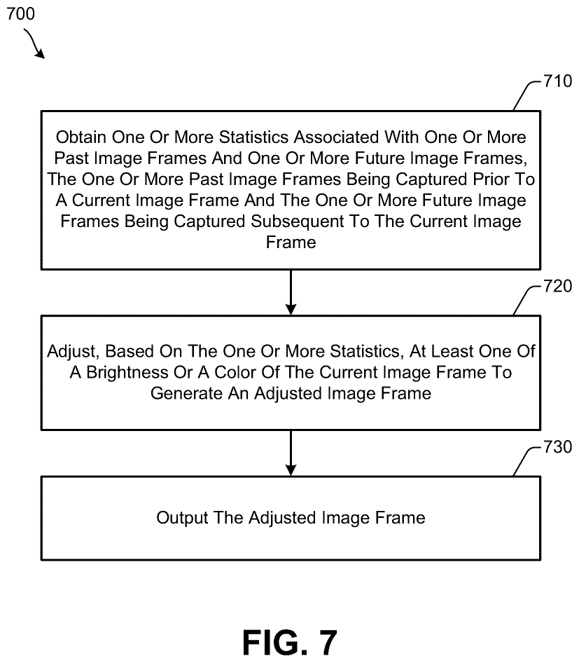

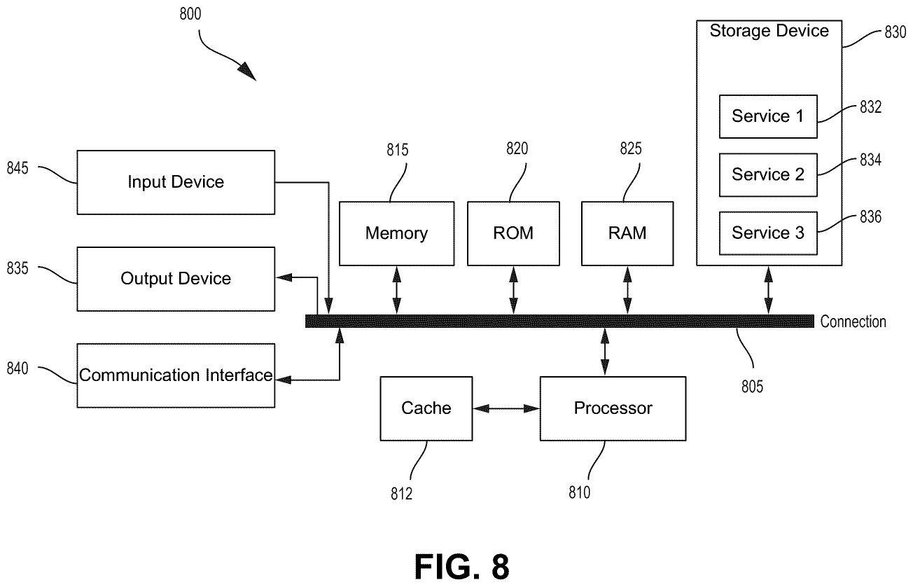

FIG. 7 is a flow chart illustrating an example of a process 700 for post AEC and AWB processing to improve video quality. The process 700 can be performed by a computing device, or by a component or system (e.g., a chipset) of the computing device. In some cases, the computing device can be or can include the system 100 of FIG. 1, the system 200 of FIG. 2, the device 300 of FIG. 3, the system 600 of FIG. 6, any combination thereof, and/or the computing system 800 of FIG. 8. The operations of the process 700 may be implemented as software components that are executed and run on one or more processors (e.g., the image processor 150, the host processor 152, and/or the ISP 154 of FIG. 1, the image processor 250, the host processor 252, and/or the ISP 254 of FIG. 2, the processor 306, the camera controller 312, and/or the ISP 314 of FIG. 3, the ISP pipeline 402 of FIG. 4, the processor 810 of FIG. 8, any combination thereof, and/or other processor(s)).

At block 710, the computing device (or component thereof) can obtain one or more statistics associated with one or more past image frames and one or more future image frames. In some cases, the one or more statistics are associated with at least one of brightness or color. The one or more past image frames are captured prior to a current image frame and the one or more future image frames are captured subsequent to the current image frame. In some cases, the one or more past image frames, the current image frame, and the one or more future image frames are part of a video. In one illustrative example, the one or more past image frames can include the past image frame M-2 620a and the past image frame M-1 620b of FIG. 6, the current image frame can include the image frame M 630 of FIG. 6, and the one or more future image frames can include the future image frame N-1 640a and the future image frame N 640b of FIG. 6. In such an example, the one or more statistics can include the statistics 675 of FIG. 6.

In some cases, the computing device (or component thereof) can buffer the one or more past image frames, the current image frame, and the one or more future image frames, such as using a preview frame buffer (e.g., preview frame buffer 610 of FIG. 6).

At block 720, the computing device (or component thereof) can adjust, based on the one or more statistics, at least one of a brightness or a color of the current image frame to generate an adjusted image frame. In some aspects, to adjust at least one of the brightness or the color of the current image frame, the computing device (or component thereof) can apply a sensor setting (e.g., a digital gain) and/or a gain (e.g., a red-green-blue (RGB) gain) to the current image frame. In one illustrative example, as described with respect to FIG. 6, the AEC and AWB engine 680 can use statistics 675 (related to brightness and tone) from the past image frame M-2 620a and the past image frame M-1 620b and from the future image frame N-1 640a and the future image frame N 640b to determine sensor settings and an AWB gain 685.

In some cases, the computing device (or component thereof) can determine the sensor setting (e.g., a digital gain) based on an automatic exposure control (AEC) decision. For instance, the computing device (or component thereof) can determine the AEC decision based on the one or more statistics. Referring to FIG. 6 as an illustrative example, when performing AEC, the AEC and AWB engine 680 can use the statistics 675 from the past image frame M-2 620a and the past image frame M-1 620b and from the future image frame N-1 640a and the future image frame N 640b to determine the sensor settings 685 (e.g., for a time and gain, such as a digital gain) for the brightness for the current image frame M 630.

In some cases, the computing device (or component thereof) can determine the gain (e.g., RGB gain) based on an automatic white balancing (AWB) decision. For instance, computing device (or component thereof) can determine the AWB decision based on the one or more statistics. Again referring to FIG. 6 as an illustrative example, when performing AWB, the AEC and AWB engine 680 can use the statistics 675 from the past image frame M-2 620a and the past image frame M-1 620b and from the future image frame N-1 640a and the future image frame N 640b to determine the AWB gain 685 (e.g., RGB gain) for the neutral color of the current image frame M 630.

At block 730, the computing device (or component thereof) can output the adjusted image frame. For instance, the computing device (or component thereof) can output the adjusted image frame for display (e.g., for video output 660 of FIG. 6), for storage, for transmission to another device, or otherwise output.

In some examples, the process 700 may be performed by one or more computing devices or apparatuses. In some illustrative examples, the process 700 can be performed by the image capture and processing system 100 of FIG. 1, the device 300 of FIG. 3, the system 600 of FIG. 6, and/or one or more computing devices or systems (e.g., the computing system 800 of FIG. 8). In some cases, such a computing device or apparatus may include a processor, microprocessor, microcomputer, or other component of a device that is configured to carry out the steps of the process 700. In some examples, such computing device or apparatus may include one or more sensors configured to capture image data. For example, the computing device can include a smartphone, a head-mounted display, a mobile device, a camera, a tablet computer, or other suitable device. In some examples, such computing device or apparatus may include a camera configured to capture one or more images or videos. In some cases, such computing device may include a display for displaying images. In some examples, the one or more sensors and/or camera are separate from the computing device, in which case the computing device receives the sensed data. Such computing device may further include a network interface configured to communicate data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 8 is a diagram illustrating an example of a system for implementing certain aspects of the present technology. In particular, FIG. 8 illustrates an example of computing system 800, which can be for example any computing device making up internal computing system, a remote computing system, a camera, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including the memory unit 815, such as read-only memory (ROM) 820 and random access memory (RAM) 825 to processor 810. Computing system 800 can include a cache 812 of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like.

The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. A method for processing image data, the method comprising: obtaining one or more statistics associated with one or more past image frames and one or more future image frames, the one or more past image frames being captured prior to a current image frame and the one or more future image frames being captured subsequent to the current image frame; adjusting, based on the one or more statistics, at least one of a brightness or a color of the current image frame to generate an adjusted image frame; and outputting the adjusted image frame.

Aspect 2. The method of Aspect 1, further comprising buffering the one or more past image frames, the current image frame, and the one or more future image frames.

Aspect 3. The method of Aspect 2, wherein the buffering is performed using a preview frame buffer.

Aspect 4. The method of any one of Aspects 1 to 3, wherein the one or more statistics are associated with at least one of brightness or color.

Aspect 5. The method of any one of Aspects 1 to 4, wherein adjusting at least one of the brightness or the color of the current image frame comprises applying at least one of a sensor setting or a gain to the current image frame.

Aspect 6. The method of Aspect 5, further comprising determining the sensor setting based on an automatic exposure control (AEC) decision.

Aspect 7. The method of Aspect 6, further comprising determining the AEC decision based on the one or more statistics.

Aspect 8. The method of any one of Aspects 5 to 7, wherein the sensor setting is a digital gain.

Aspect 9. The method of any one of Aspects 5 to 8, further comprising determining the gain based on an automatic white balancing (AWB) decision.

Aspect 10. The method of Aspect 9, further comprising determining the AWB decision based on the one or more statistics.

Aspect 11. The method of any one of Aspects 5 to 10, wherein the gain is a red-green-blue (RGB) gain.

Aspect 12. The method of any one of Aspects 1 to 11, wherein the one or more past image frames, the current image frame, and the one or more future image frames are part of a video.

Aspect 13. An apparatus for processing image data, the apparatus comprising: at least one memory; and at least one processor coupled to the at least one memory and configured to: obtain one or more statistics associated with one or more past image frames and one or more future image frames, the one or more past image frames being captured prior to a current image frame and the one or more future image frames being captured subsequent to the current image frame; adjust, based on the one or more statistics, at least one of a brightness or a color of the current image frame to generate an adjusted image frame; and output the adjusted image frame.

Aspect 14. The apparatus of Aspect 13, wherein the at least one processor is configured to buffer the one or more past image frames, the current image frame, and the one or more future image frames.

Aspect 15. The apparatus of any one of Aspects 13 or 14, wherein the at least one processor is configured to buffer the one or more past image frames, the current image frame, and the one or more future image frames using a preview frame buffer.

Aspect 16. The apparatus of any one of Aspects 13 to 15, wherein the one or more statistics are associated with at least one of brightness or color.

Aspect 17. The apparatus of any one of Aspects 13 to 16, wherein, to adjust at least one of the brightness or the color of the current image frame, the at least one processor is configured to apply at least one of a sensor setting or a gain to the current image frame.

Aspect 18. The apparatus of Aspect 17, wherein the at least one processor is configured to determine the sensor setting based on an automatic exposure control (AEC) decision.

Aspect 19. The apparatus of Aspect 18, wherein the at least one processor is configured to determine the AEC decision based on the one or more statistics.

Aspect 20. The apparatus of any one of Aspects 17 to 19, wherein the sensor setting is a digital gain.

Aspect 21. The apparatus of any one of Aspects 17 to 20, wherein the at least one processor is configured to determine the gain based on an automatic white balancing (AWB) decision.

Aspect 22. The apparatus of Aspect 21, wherein the at least one processor is configured to determine the AWB decision based on the one or more statistics.

Aspect 23. The apparatus of any one of Aspects 17 to 22, wherein the gain is a red-green-blue (RGB) gain.

Aspect 24. The apparatus of any one of Aspects 13 to 23, wherein the one or more past image frames, the current image frame, and the one or more future image frames are part of a video.

Aspect 25. A non-transitory computer-readable medium having stored thereon instructions that, when executed by at least one processor, cause the at least one processor to perform operations according to any of Aspects 1 to 12.

Aspect 26. An apparatus for processing image data, the apparatus comprising one or more means for performing operations according to any of Aspects 1 to 12.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. A method for processing image data, the method comprising:
obtaining one or more statistics associated with one or more past image frames and one or more future image frames, the one or more past image frames being captured prior to a current image frame and the one or more future image frames being captured subsequent to the current image frame;
adjusting, based on the one or more statistics, at least one of a brightness or a color of the current image frame to generate an adjusted image frame; and
outputting the adjusted image frame.

2. The method of claim 1, further comprising buffering the one or more past image frames, the current image frame, and the one or more future image frames.

3. The method of claim 2, wherein the buffering is performed using a preview frame buffer.

4. The method of claim 1, wherein the one or more statistics are associated with at least one of brightness or color.

5. The method of claim 1, wherein adjusting at least one of the brightness or the color of the current image frame comprises applying at least one of a sensor setting or a gain to the current image frame.

6. The method of claim 5, further comprising determining the sensor setting based on an automatic exposure control (AEC) decision.

7. The method of claim 6, further comprising determining the AEC decision based on the one or more statistics.

8. The method of claim 5, wherein the sensor setting is a digital gain.

9. The method of claim 5, further comprising determining the gain based on an automatic white balancing (AWB) decision.

10. The method of claim 9, further comprising determining the AWB decision based on the one or more statistics.

11. The method of claim 5, wherein the gain is a red-green-blue (RGB) gain.

12. The method of claim 1, wherein the one or more past image frames, the current image frame, and the one or more future image frames are part of a video.

13. An apparatus for processing image data, the apparatus comprising:
at least one memory; and
at least one processor coupled to the at least one memory and configured to:
obtain one or more statistics associated with one or more past image frames and one or more future image frames, the one or more past image frames being captured prior to a current image frame and the one or more future image frames being captured subsequent to the current image frame;
adjust, based on the one or more statistics, at least one of a brightness or a color of the current image frame to generate an adjusted image frame; and
output the adjusted image frame.

14. The apparatus of claim 13, wherein the at least one processor is configured to buffer the one or more past image frames, the current image frame, and the one or more future image frames.

15. The apparatus of claim 13, wherein the at least one processor is configured to buffer the one or more past image frames, the current image frame, and the one or more future image frames using a preview frame buffer.

16. The apparatus of claim 13, wherein the one or more statistics are associated with at least one of brightness or color.

17. The apparatus of claim 13, wherein, to adjust at least one of the brightness or the color of the current image frame, the at least one processor is configured to apply at least one of a sensor setting or a gain to the current image frame.

18. The apparatus of claim 17, wherein the at least one processor is configured to determine the sensor setting based on an automatic exposure control (AEC) decision.

19. The apparatus of claim 18, wherein the at least one processor is configured to determine the AEC decision based on the one or more statistics.

20. The apparatus of claim 17, wherein the sensor setting is a digital gain.

21. The apparatus of claim 17, wherein the at least one processor is configured to determine the gain based on an automatic white balancing (AWB) decision.

22. The apparatus of claim 21, wherein the at least one processor is configured to determine the AWB decision based on the one or more statistics.

23. The apparatus of claim 17, wherein the gain is a red-green-blue (RGB) gain.

24. The apparatus of claim 13, wherein the one or more past image frames, the current image frame, and the one or more future image frames are part of a video.

25. A non-transitory computer-readable medium having stored thereon instructions that, when executed by at least one processor, cause the at least one processor to:
obtain one or more statistics associated with one or more past image frames and one or more future image frames, the one or more past image frames being captured prior to a current image frame and the one or more future image frames being captured subsequent to the current image frame;
adjusting, based on the one or more statistics, at least one of a brightness or a color of the current image frame to generate an adjusted image frame; and
outputting the adjusted image frame.

26. The non-transitory computer-readable medium of claim 25, further comprising instructions that, when executed by at least one processor, cause the at least one processor to buffer the one or more past image frames, the current image frame, and the one or more future image frames.

27. The non-transitory computer-readable medium of claim 25, wherein the one or more statistics are associated with at least one of brightness or color.

28. The non-transitory computer-readable medium of claim 25, wherein, to adjust at least one of the brightness or the color of the current image frame, the instructions, when executed by at least one processor, cause the at least one processor to apply at least one of a sensor setting or a gain to the current image frame.

29. The non-transitory computer-readable medium of claim 28, further comprising instructions that, when executed by at least one processor, cause the at least one processor to determine the sensor setting based on an automatic exposure control (AEC) decision determined based on the one or more statistics.

30. The non-transitory computer-readable medium of claim 28, further comprising instructions that, when executed by at least one processor, cause the at least one processor to determine the gain based on an automatic white balancing (AWB) decision determined based on the one or more statistics.
